(19) United States
(12) Patent Application Publication
(10) Pub. No.: US 2002/0019938 A1
(43) Pub. Date: Feb. 14, 2002

(54) Method and apparatus for secure identification for networked environments

(76) Inventor: Michael Thomas Aarons, Fountain Valley, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/921,733

(22) Filed: Aug. 3, 2001

Related U.S. Application Data
(60) Provisional application No. 60/223,204, filed on Aug. 4, 2000.

(51) Int. Cl. H04L 9/00

(52) U.S. Cl. 713/168; 713/185

(57) ABSTRACT

Described is an apparatus for containment of Digital Personal Identity Signatures for use in completing and signing documents in a network or Internet environment. The apparatus contains a digital signature certificate issued by a third party that is used in place of an actual signature to allow completion of binding contracts through the use of a computer used over an Internet or Intranet environment. The apparatus includes a custom designed Compact Disc containing encrypted data and software that is used to access the digital signature in a secure environment. Access to the data is provided in a secure environment by requiring the use of an access password or Personal Identification Number, an alphabetic pass phrase or, an alphanumeric pass phrase to prevent fraudulent use of the digital signature in the event of loss or theft of the apparatus.

This invention claims priority under 35 U.S.C. 119(e) to U.S. Provisional Application No. 60/223,204, filed Aug. 4, 2000.

### FIELD

This invention relates to the use of Digital Signature contained on a small compact disc or CD. The invention allows the use of a Digital Signature for use on the Internet or locally. President Bill Clinton signed the use of Digital Signatures into law in October of 2000.

### BACKGROUND

This invention allows the Digital Signatures or “Digital Certificates” assigned to a person to be maintained in a portable manner for secure use on one or more computers.

The user inserts the CD containing the digital signature into a computer and enters a password or pass phrase to gain entry to one or more digital signatures contained on the CD. The use of the password or pass phrase prevents the personal signature from being used fraudulently in the event the Digital Signature card is lost or stolen.

Digital Signatures are actually “Digital Certificates” issued by certain existing “Certificate Authorities” or “CAs.” The digital signature forms part of a key for the encryption of the document being signed. Software incorporates the encryption key in a method to ensure that if the document is modified in any form after signing, the fact that it was modified will be detectable and will indicate a forged or modified document.

Digital Signatures can be maintained in many forms. This invention makes use of a smaller size CD that can be carried in a wallet or purse but still be used by the majority of personal computers in operation today.

This invention also has the capability of holding and presenting the owner's image of his or her cursive handwritten signature, and image of the owner's thumbprint, obtained when the card is created, or a digital photograph of the card owner.

Digital Signatures have been in existence for many years. They are in actuality, “Digital Certificates” but are used on a personal basis. Digital Certificates are issued by a select group of companies that refer to themselves as being a “Certificate Authority” or CA. It is the prime responsibility of a CA to issue Digital Certificates in a highly secure and verified method. The CA must ensure that the person or company requesting the Digital Certificate is who they say they are and then the CA must deliver the Digital Certificate to the requesting party in a secure manner.

Prior art maintains Digital Certificates in a totally digital manner. Although different CAs have different protocols, the general protocol behaves in the following manner; A user requests a Digital Certificate from a CA via Internet E-Mail. After verification of personal data, the user is notified via E-Mail where the Digital Certificate can be obtained using a “Web Browser” on the Internet and accessing a specific site included in the E-Mail. Once the site is accessed, the Digital Certificate is transferred to the user's computer and maintained as part of the user's operating system.

A typical computer user does not have the knowledge to transfer the Digital Certificate from computer to computer so must then request individual certificates for each computer. With prior art, at no time is the Digital Certificate maintained in a portable manner such as on a CD or on a floppy disk.

This invention allows the portability of Digital Certificates by storing the Digital Certificate on portable media that can be moved from one computer to another. This invention also protects the use of the Digital Certificate by encrypting the certificate on the media and requiring a password or pass phrase to be used to access the certificate. Prior art allows access to Digital Certificates stored on a computer not only by the original owner but by individuals knowable in the field of Operating Systems or computer maintenance.

Additionally, certificates have a finite lifetime. They are actually public/private key pairs that, if given enough computer time, can be broken. With current compute power, it is estimated that the keys used can be broken with 40 years of super computer time. Since computing power increases with each passing year, there needs to be a method to rotate the use of certificates. Prior art makes a certificate valid for a finite period, typically one year. At the end of that period, a new key is issued for replacement of the current key. Prior art maintains that the original owner of the digital signature must reapply for a new digital signature. There is no automation currently involved in digital signatures.

This invention is designed to include more than one key pair on a single CD. The key pairs can be changed at periodic intervals so that new keys are used and the possibility of breaking the keys is reduced. In the event that a key is compromised, a new key can be used as replacement almost immediately. Each key pair can be protected by a different password or pass phrase. Two methods exist to rotate the key pairs. Either the current date, specifically the year, can be used to automatically select a key pair or the use of a new pass word or phrase allows the next recorded key pair to be used. If the date is used, it can optionally become part of the pass phrase by being entered automatically for user. In such a case, it would be possible to substitute the new key pair with out the user ever knowing that the key is new.

The typical lifetime of the invention is intended to be three years, therefore, a minimum of three signature keys are stored on the invention and rotated on an annual basis. Additional keys can be stored on the invention in the event that one or more keys are compromised and no longer can be considered secure. In this case, a new key pair is available almost instantly since the card owner already has the additional keys in his or her possession.

Prior art, such as Automatic Teller Machine cards or ATM cards, make use of a 4 to 8 digit “Personal Identification Number” or PIN to protect the card from fraudulent use. On a typical 4 digit PIN ATM card, it only requires a fraudulent user 10,000 attempts to break the PIN number. Given the use of current compute power, this may require a couple of seconds of compute time. This invention improves on the use of a PIN while still providing flexibility to the issuing party. This invention allows the use of any number of digits or even the replacement of the PIN by a “Pass Phrase.” A pass phrase can be a sentence entered on the keyboard or string of digits that can be remembered by their pattern.

The key to the use of Pass Phrases is that the longer the phrase, the more secure the card access. At the current time, the use of 128-bit encryption would require 32 digits or 19 alphabetic characters. Numeric data is required on ATM machines mainly because an alphanumeric keyboard does not exist. The use of 32 digits is essentially too taxing to the normal human being. The use of a pass phrase is much easier to remember. Since this invention almost always exists in an environment where an alphanumeric keyboard exists, the use of pass phrases is possible. The invention is adaptable to the needs of different users and different issuers in that any number of digits or letters can be used knowing that the more letters or digits used the greater the security on the card.

Prior art exists for the access of specific web sites on the Internet or data available on the Internet or in a networked environment. This art is usually in the form of an onscreen display that requests a user name and password. In this case, the user will enter the name and password and transfer the information over the Internet. Although secure methods exist to transfer data, the fact that anyone knowledgeable in Internet traffic can intercept the data and eventually read it makes this type of data entry undesirable. Additionally, the user name and passwords used do not represent very many alphanumeric digits and are thus susceptible to “cracking” with the use of modem computer equipment. This invention improves on this method by allowing the user to enter the password, PIN or pass phrase in a local environment where it can be verified on the user's computer and is never transferred over the Internet or private network. Once the access code has been entered locally, more advanced encryption is made available from data stored on the card. Thus a higher level of security is maintained and easily decrypted data is never sent over open lines.

Prior art such as credit cards and ATM cards do not protect the data through the use of encryption. This invention improves on prior art by using the pass phrase or PIN as the actual key to decrypt the data. When the card is created, the pass phrase or PIN is used as the key to encrypt the data. The data is then recorded on the invention in encrypted form. Software, made available either from the invention or over the Internet, is then used to accept the pass phrase or PIN from the user and then used to decrypt the data. In this manner, the data is kept secure in the event that the invention is lost or stolen. Although the data can be read in any CD ROM recorder, encryption keeps the data from being used in a fraudulent manner.

Prior art, such as credit cards, make use of the owner's cursive signature to be used in comparison to signify proper and legal use. This invention, in one of its forms, allows the owner's cursive signature to be digitally scanned and stored on the invention. Software is then used during the signing of legal documents to read the scanned signature from the invention and place it in a proper location on the legal document such that the scanned signature appears as if the owner had manually signed the document. Although not required by law, the scanned signature is provided on the document as a courtesy to the owner.

Prior art, such as Notary Publics, make use of a thumbprint taken at the same time the document is signed. The thumbprint forms an auditing path should the source of the signature ever be questioned in the future. This invention improves on prior art in allowing the use of a digitally scanned thumbprint to be taken when the invention is initially created for the user. The thumbprint is stored on the invention for courtesy use much in the manner as the scanned cursive signature described above.

Prior art does not actually encrypt a document to prevent it form being viewed by undesirable entities. Currently available devices generate what is typically called a “hash” code that is appended to the end of document. The purpose of the hash code is that it indicates that one or more portions of the document have been changed in the event that running the algorithm again on the document does not generate the same hash code.

This invention improves on prior art by not only including the hash code but also allowing the user to encrypt the document with the user's private key thus making the document viewable to those using the user's public key. In general, the use of public/private keys maintains that the public key be made available to all. But, at the user's discretion, the public key can be made available to only select parties thus preventing others from viewing the document.

Prior art, such as a driver's license or some other form of identification, is required in most cases, to cash a bank check such as a personal check or a payroll check. Currently, there is no method to send a driver's license or other form of pictured identification over the Internet or in a local network.

This invention improves on prior art by allowing the user to securely transfer identification and even photographs of the user in a highly secure manner such that it can be ascertained with a high amount of confidence that the user is exactly who they claim to be. Such a use for the invention would be in the area of receiving and transferring payroll or personal checks, receiving income tax refunds and allowing the transfer of funds from one bank account to another.

This invention also has opportunities of use in providing secure access to portable personal computers. Prior art exists that prevents entry to the computer if a proper password is not entered. Prior art also exists that prevents access to the personal computer in the event that a finger or thumbprint entered into a fingerprint reader does not match the fingerprint already programmed into the personal computer.

This invention improves on prior art by providing a key to access the personal computer. In this case, the key is in the form of a small CD that is placed in the CD reader prior to logging into the computer. The CD provides a longer, more secure form of password to the BIOS that is used to start the computer's operating system. The advantage of the invention over a standard password is that not only is the password longer and more secure, the user never needs to enter the password and thus cannot be watched by someone intending to learn the user's password and access the computer at a later time. To secure the computer, the user needs only to remove the CD and place it in a secure location such as a wallet or purse.

This invention also improves on current art by becoming a deterrent for the hijacking and theft of computers while in transit from the manufacturer to the buyer. By sending the “key” or CD via a different method, such as U.S. Mail, computers in transit cannot be accessed if the shipment is hijacked or stolen. In this case, the computers would be useless to those intending to use them in a fraudulent manner.

In providing security for personal computers, it is known to use passwords accepted by the software modules used to start up the computer.

There are also fingerprint scanners that require the user to press a fingerprint on the computer before entering. And, there are keys that are inserted into ports on the computer before the computer can be started.

Some of these make use of existing hardware on the computer and some require new hardware.

Currently defined digital signatures or digital certificates are provided on a computer to computer basis. The user must request a signature or certificate and the certificate is installed on a specific computer. There is no means of portability for such a signature or certificate.

In the area of identifying a specific user of a computer, computers have existed for some time that provide a unique serial number to identify a specific computer but and effort to coordinate the user and serial number has been fraught with problems relating to the user's anonymity. Additionally, identifying the computer does not implicitly identify the user of the computer thus, any person working on a publicly available computer could pretend to be some other user.

Identification exists in the form of driver's licenses that contain magnetic stripes or credit cards and automatic teller machine cards that require the input of some form of password but unfortunately, most current day computers lack the ability to read such instruments thus rendering them useless in the computer realm.

### SUMMARY

It is therefore an object of the present invention to provide a method of storing a digital signature or digital certificate for the purpose of making such a signature or certificate portable for use on one or more computers. The storage of the information is specifically a miniature form of CD or DVD that allows the invention to be kept in the user's wallet or purse.

It is also an object of the present invention to encrypt the digital signature or certificate for the purpose of providing protection of the personal information in the event that the invention is lost or stolen. A password or pass phrase is required to access the digital signature or certificate. The password is, additionally, entered on the local computer and never transferred over a networked environment. The password allows decryption of the digital signature or certificate only on the local computer.

It is also an object of the invention to provide the capability of storing more than one digital signature or certificate for the purpose of aging the signature or certificate. It is intended that each signature be used for defined period, such as one year, and the next available signature be used following the current period. Additional capability is included in the invention to provide additional signatures or certificates, on an immediate basis, in the event that the current signature or certificate is compromised. An option is provided in the invention for the use of a the current date as part of the password to activate a particular signature or certificate. The date can be kept as either a digital date, such as “2005” and entered as part of the password or can be encoded into the password and appear as some obscured number or phrase. Each of the additional signatures can also be protected by different passwords or PINs that can be made available to the user on a secure link. These could be used for instance in the case when a current digital signature has been compromised and the user needs immediate access to another secure digital signature. By transferring the information to the user over telephone or some other one-to-one method, the password or PIN can be provided to the user and immediate access to the next digital signature can be provided with no delay to the user.

It is also an object of the invention to prevent the transfer, over a networked environment, of the information required to decrypt the digital signature or certificate. To accomplish this object, locally executed software modules are used to accept the user's password or pass phrase on the user's own computer and decrypt the digital signature or certificate locally. The user's password or pass phrase to access the information contained on the invention is never transferred over the networked environment. Additionally, these software modules can reside on the invention itself or be loaded into the user's computer via the networked environment. The advantage provided by downloadable software is that it can be updated from a central location and the user need not be aware that new or better software components are being used to decode the password or pass phrase used to access the information. The downloaded software can also be modified on an annual basis to age the digital signature or certificate and use the next available signature or certificate with or without the user's knowledge.

It is also an object of the invention to provide a “courtesy image” of the user's actual signature. The signature is scanned from an actual signature of the user when the application for a digital signature or certificate is processed. The actual signature is maintained in a format compatible with computer programs of standard use. Such formats would be bitmaps, GIFs or JPEG images. While the courtesy image does not contain any legal weight, it is provided as an indicator that the document has been enclosed in a digital signature. This manner is physically similar to a notary public stamping a document with a notary stamp. The actual legal signature is provided by the use of an industry standard “hashing” algorithm that incorporates the users digital signature or digital certificate in a manner such that if any portion of the document is altered, the “hashing” algorithm would detect the fact. Since the courtesy signature is also included in the document when “hashing” is performed, it too is guarded against any alteration and as such may have legal significance if covered by future laws.

It is also an object of the present invention to provide a means of storing public and private keys that are the actual digital signature or digital certificate. It is desirable to give out the public key so that the public key or include it with the document so that the document may be decrypted or “rehashed” by others to ensure authenticity. Industry standard rules dictate that public keys are made publicly available and a public key can only decrypt a document encrypted with a private key. Therefore the user or owner of the digital signature would use the private key to “hash” the document. Therefore the public key could be used to perform additional “hashing” operations to ensure authenticity of the document. Including the public key with the document as a courtesy makes it easy to qualify the document and ensures that the key is never lost.

It is also the object of this invention to provide a longer life for the media by storing the data containing one or more digital signatures or certificates a multitude of times on the media. By storing more than one copy of the data, other copies can be used in the event that the first copies are not readable. Should the media become damaged, the software module that reads the signature would look for additional copies on the media and use the next uncorrupted image of the data.

It is also the object of this invention to incorporate the use of this invention to identify to a high degree, to corporations existing at the other end of a networked environment that the owner of this card is who they claim to be. By ensuring authenticity of the owner through the need to physically have the invention in possession and in the computer and the need to have the proper password or pass phrase to access the invention, a remote company can be relatively assured that who they expect is in operation of the invention. This can lead to possible business avenues such as certified delivery of electronic mail or delivery of financial check instruments that can be printed by the user. Additionally, financial check instruments can be delivered to the end user in an encrypted manner that only the user's private key can decrypt or encrypted versions of the check be made available to the user for downloading and decryption by the user only. This is possible because of the private—public key concept used for digital signatures. The check instrument is encrypted with the user's public key, which is made available either by the user or some institution that performs such a function. Since the check instrument can only be decrypted by the user's private key (through the use of the invention) it is assured that only the real owner can decrypt and print the check instrument for use as a traditional check in a financial institution.

Additionally, the invention may be incorporated by government entities for use in proper identification of the user over a networked environment. Example usage might be for submitting income tax information electronically or receiving or paying income tax monies. The user might also be able to securely access Social Security and Internal Revenue Service data that pertains strictly to the user. The invention provides a much higher degree of security than present art that incorporates a Social Security Number and a password.

In is also an object of the invention to protect access to personal computers. The invention would be required to be inserted in the computer's CD-ROM or DVD drive prior to starting the operating system. The user would be required to enter a PIN or password or pass phrase. The computer would access the invention for the encrypted password and compare the password to the password already stored in the computer. If the passwords match, the operating system is allowed to continue loading. If the passwords do not match, the system halts preventing access to the user's information. Such a system could also be used from deterring theft of the computer while it is in shipping from the manufacturer to the purchaser. The factory would combine the computer and invention during configuration. The invention would then be shipped to the user by a different method than the computer. This method would copy existing art for credit cards where the credit card is shipped from one location and the PIN for the credit card is shipped from another location making it difficult to connect the two items. In this case the computer would be shipped from the manufacturer by traditional bulk shipping methods while the invention is shipped from one location by U.S. Mail and the PIN is shipped from the same or different location by U.S. Mail or via electronic mail. The main advantage in this situation would be that if the computer is stolen during shipping, the thief is unable to access the operating system making the computer essentially useless.

### BRIEF DESCRIPTION OF THE DRAWINGS

FIG. 1 is a plain view of the preferred embodiment of the invention.

FIG. 2 is a top view of an alternative embodiment.

FIG. 3 is an isometric view of an alternative embodiment.

FIG. 4 is an isometric view of an alternative embodiment. FIG. 4 also shows prior art of the invention that generated FIGS. 1 through 3.

FIG. 5 is the preferred embodiment shown in the desired storage location for wallet.

FIG. 6 is an isometric view of a conventional CD-ROM or DVD drawer used to read the invention.

FIG. 7 is a flow diagram depicting prior art for attaining and receiving a Digital Signature or Certificate.

FIG. 8 is a flow diagram of the preferred embodiment of attaining and storing the user data along with the digital signature and pass phrase.

FIG. 9 is a flow diagram of the preferred embodiment for using a rollover date in combination with a pass phrase.

### DETAILED DESCRIPTION

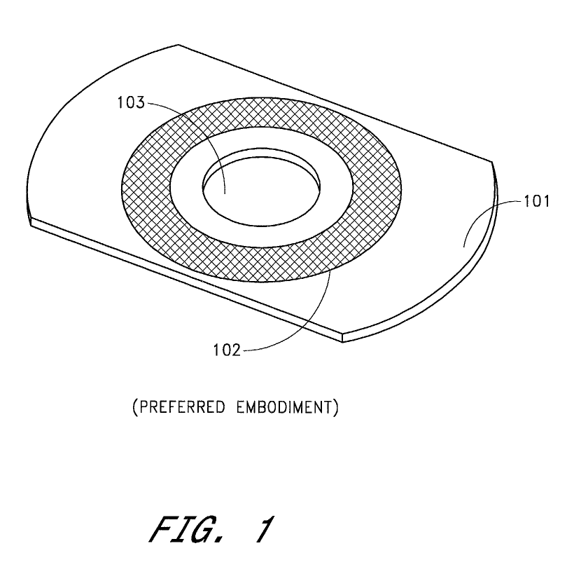

Referring to the drawings, in FIG. 1 the preferred embodiment of the media used to hold the invention is shown. This media is not unique, it has been used in the industry mostly to contain multimedia business cards. It is the preferred embodiment as container of this invention solely because of its small form factor and the ability to reside within a purse or wallet. Item 101 is the stock media. This stock can have multiple shapes and sizes as defined later. Item 102 is the data area where the invention is recorded and subsequently read. Item 103 is the hub of the stock media. Regardless of form, all media must have this hub in order to be held by the recording and reading mechanisms.

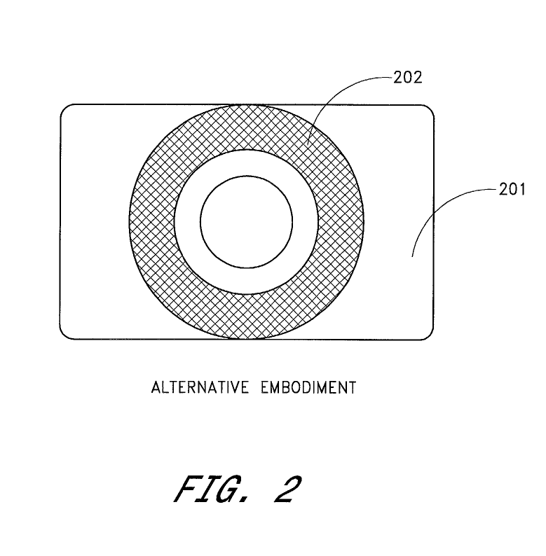

FIG. 2 depicts an alternative embodiment of the media used to contain the invention. The media is made in this format so that it may more closely resemble a standard credit card used for financial transactions. Item 201 is the stock media and item 202 depicts the area where the invention is stored.

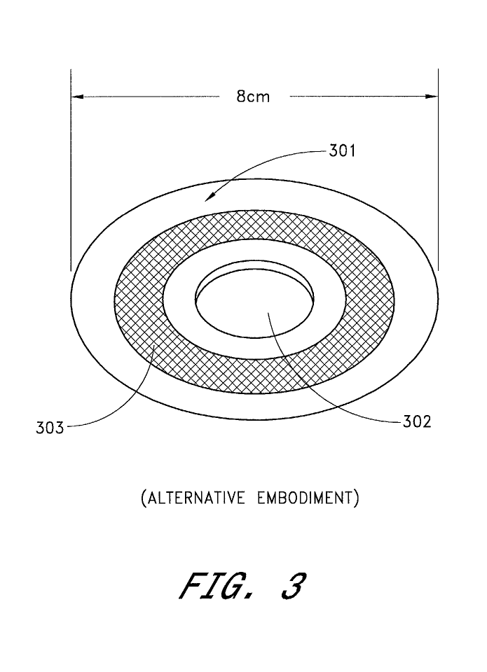

FIG. 3 shows another alternative embodiment of the container to hold the invention. The diagram shows a standard 8 cm CD-R. Item 301 is the stock media, item 302 is the hub and item 303 depicts the data area used to contain the invention. Although this form of media can contain much more data than the previous embodiments, it is not as portable as the previously shown embodiments.

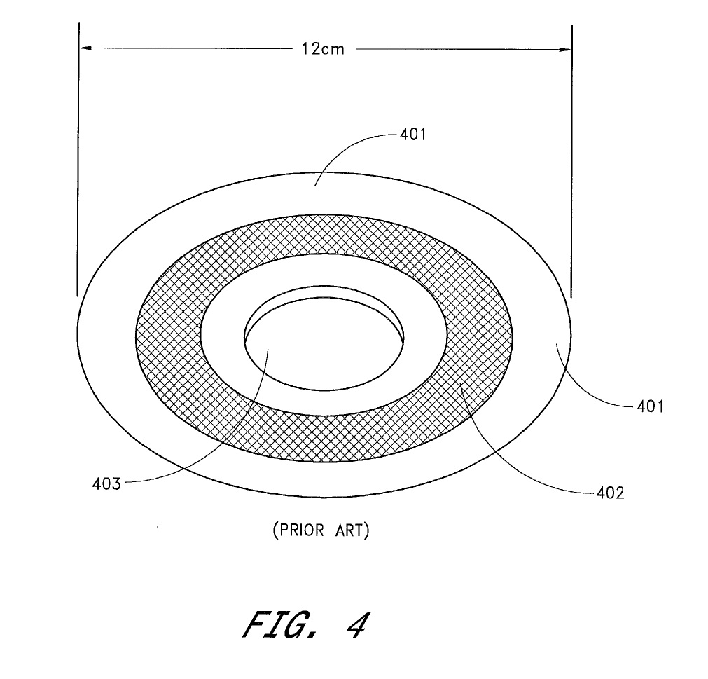

FIG. 4 depicts standard CD, CD-R, and DVD physical characteristics that define prior art that led to the creation of the preferred containers for the invention. The disc is 12 cm in diameter. Item 401 is the stock media, item 402 is the data area containing the invention and item 403 is the hub. Such a format, while useful for containing a large amount of data is not as portable as prior descriptions of media.

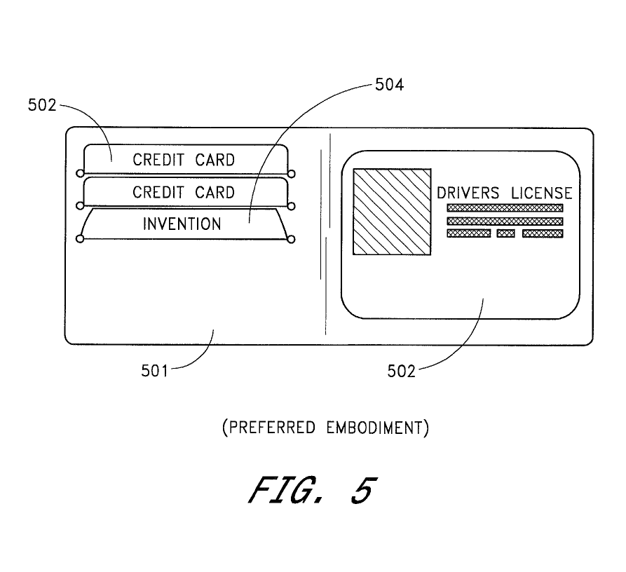

FIG. 5 shows the invention recorded on the preferred container in place within a standard wallet (Item 501). Since the invention is included on such a small form factor it is possible to carry the invention (Item 504) in a manner similar to standard credit cards (Item 503). In multiple embodiments, the invention can contain digital information equivalent to the Driver's License depicted in Item 502.

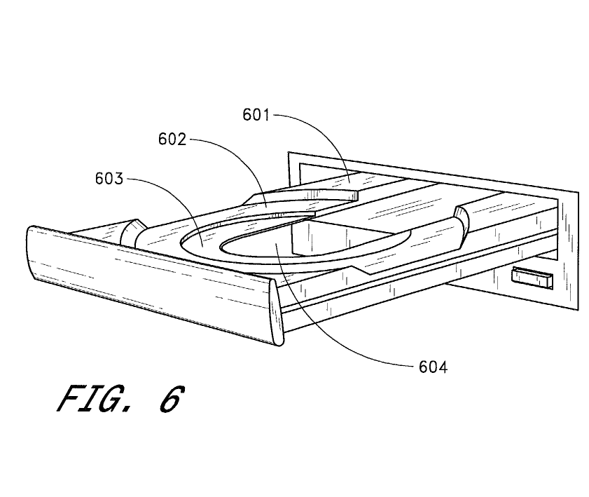

FIG. 6 shows a standard drawer for a CD, CD-R or DVD drive. Item 601 is the drawer that is typically ejected from the computer to accept the placement of media. Item 602 shows the indent that contains the larger 12-cm media. Item 603 shows the indent that is contained in most standard device to accept the smaller 8 cm media. Although the indent is circular, it is able to directly accept the media depicted in FIG. 1 and can accept the media shown in FIG. 2 because of indents or lips on the media that allow it to be centered over the hub (Item 604).

In its simplest form, the invention contains only a digital signature that is used to protect a document from future tampering and change. The digital signature is attained from a Certificate Authority (or CA) that issues such signatures. Generally, the CA will ensure that the person requesting the digital signature is exactly whom they claim to be. Without such a guarantee, any individual could request the identity of any other individual.

This invention improves on current art by optionally including a digital version of the requestor's cursive signature or picture or fingerprint. In the event that the CA does not follow industry standard guidelines in identifying the requester, an audit trail is provided to identify the requester either visually, via fingerprints or via cursive signature.

It is the preferred procedural embodiment of the this invention to make this invention available only through a notary public service or some entity that can be trusted to ensure that fraudulent ID cards are not generated. Such a notary public would verify that the requestor is who they claim to be by examining multiple other IDs to ensure the requestor is properly identified. The notary public would incorporate equipment designed specifically for creating the invention.

Such equipment would consist of a computer that has access to Internet or direct connect entities. These entities would be Certificate Authorities. The apparatus would consist of a form of digital camera to capture the current photographic image of the requestor in a digital format. The apparatus would also contain a means of gathering a cursive signature from the requestor via scanning technology where the signature is written on paper and then scanned or through a signature pad where a special pen and pad are used to attain a digital image of the signature. Additionally, a thumbprint or fingerprint scanner can be included in the apparatus for collecting an image of the requestor's thumbprint or fingerprint. This data would then be collected in a common data block and the CA accessed either by direct or secured Internet access. One or more signatures would be requested from the CA. The need for multiple signatures is discussed later.

The requester is asked to generate a pass phrase that will be used to access the digital signature at a later date. The apparatus will accept the pass phrase from the requestor in a direct manner such that the notary public or issuing body will never know the requestor's pass phrase.

The pass phrase can also be a standard four digit Personal Identification Number (PIN) or a standard short form password but, in general, the longer the pass phrase, the more secure the data protected by it.

The pass phrase is used to generate a public/private key set that will be used to encrypt the data. The rules of public/private keys sets dictate that whatever is encrypted with the public key can only be decrypted with the private key and whatever is encrypted with the private key can only be decrypted with the public key.

The pass phrase is essentially the public key (known only to the requestor but public in the sense that the requester has knowledge of the key.) The private key is used once to encrypt the data specific to that particular pass phrase and is then discarded so that it may never be used again.

The requester is now in possession of pass phrase that will unlock his digital signature and any other data recorded at the time of issuing the signature. The unique feature of this invention is that the pass phrase is never recorded on the media, it is merely the key to unlock the media. Thus, the key is harder to extract in a fraudulent manner because it never resides on the media as a piece of data.

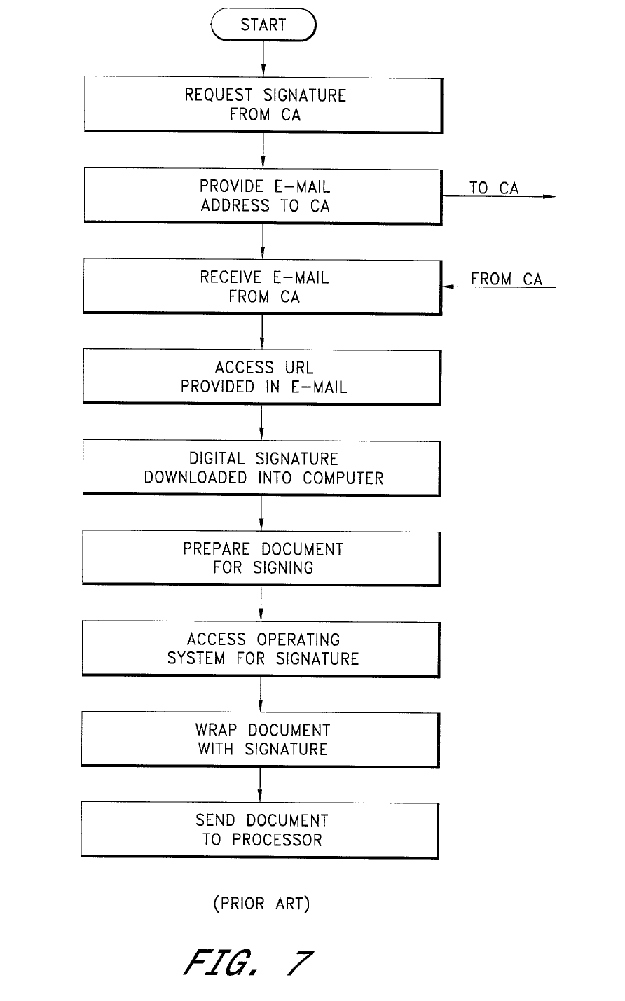

FIG. 7 shows a flow diagram of the current method of attaining a Digital Signature. The process starts by a user going online via Internet or some direct means to a Certificate Authority. The user is requested to submit some form of personal information. Methods vary with CAs but in most cases the information is verified through another secure channel like direct dialed telephone to ensure the CA is dealing with one specific person. There exists a hole in the current verification process in that the requestor of the digital signature is never asked to prove whom they claim to be. None-the-less, if the requester can provide a valid e-mail address, the process continues.

The CA will then follow specific guidelines and make a decision on whether or not to issue the digital certificate or digital signature. If the decision is made to issue the signature, the requestor will receive an e-mail listing a specific web site to access to attain the digital signature.

The requestor accesses the specified web site and the digital signature is downloaded into the computer used to access the web site. The signature is downloaded into a portion of the operating system that is claimed to be secure but is accessible to individuals with reasonable knowledge of the operating system. When stored in this manner, any person having access to this specific computer may effectively use the signature.

Once the signature is contained on the computer a document can be prepared for signing. Although a public/private key set is used for the signature, a “signed” document is not encrypted. The digital signature is used to create a special code called a “Hash Code” that has the ability to flag if any portion of the document has been modified. Even the minutest changes can be easily detected.

Once the document has been “hashed” it is usually delivered to the processor of the document in digital means initiated by the requester or submitted to the processor by automated means. There is usually no check to ensure that the processor is legitimate thus allowing a means of releasing personal information to an unknown identity.

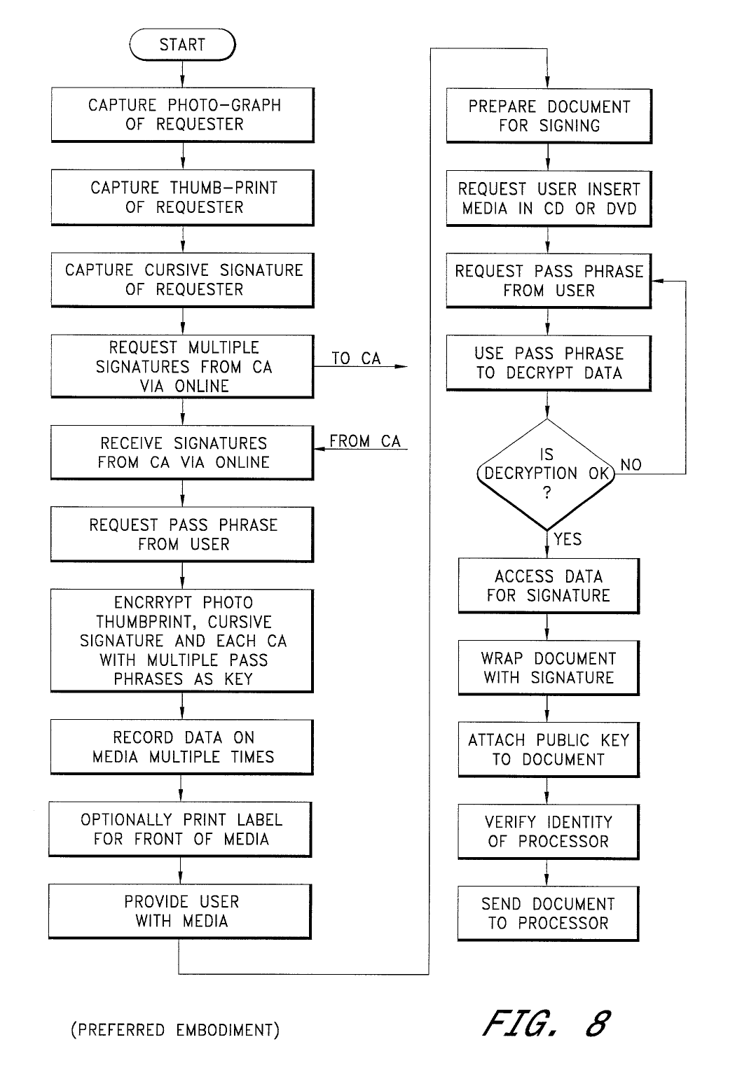

FIG. 8 shows a flow diagram for one of the preferred embodiments of the invention. The process starts at a predefined business operation that requires a requestor to visit the location and present one or more forms of identification that will ensure the requester is genuinely whom they claim to be. The predefined business operation will be termed the Issuer.

The Issuer employs equipment that is minimally connected to some Certificate Authority. This connection can be through secured Internet access or by some form of direct connection. The equipment can also contain additional devices that can digitally record a photograph of the requestor, accept a cursive signature of the requester and store it digitally or can accept a thumbprint or fingerprint of the requester. This data is collected and stored on the invention for use in various ways on the final document.

The digital photograph of the requestor can be used when a physical resemblance is required, much in the same method photographs are used on standard driver's licenses.

The fingerprint can be used much the way fingerprints are currently used with notary publics and in some instances for cashing a check. Some banks currently require patrons to leave an image of their thumb or fingerprint on the backside of a check they are cashing. This provides an audit trail that may be later used to identify the person if the check was used in a fraudulent manner. In much the same manner, a user of the invention can cash a check online and still provide an audit trail that would protect the financial institution.

The digital image of the cursive signature does not truly contain weight when used online but can be used in a courtesy manner to signify that a specific document has indeed been digitally signed. In this case the image of the cursive signature would be placed in the document image at the locations that are traditionally signed if the document were traditional ink and paper media.

Once the physical data has been collected from the requester, the CA is accessed to request one or more digital signatures. While only one digital signature is required to create the invention, the inclusion of multiple signatures is a unique feature of one of the invention's embodiments.

The use of multiple signatures on a single card allows for aging of the signatures and provides for cases that can allow the requestor to change signatures immediately in the event that a current signature is compromised. This improves on prior art such as credit cards that must cancel the current account number and send replacement cards via mail.

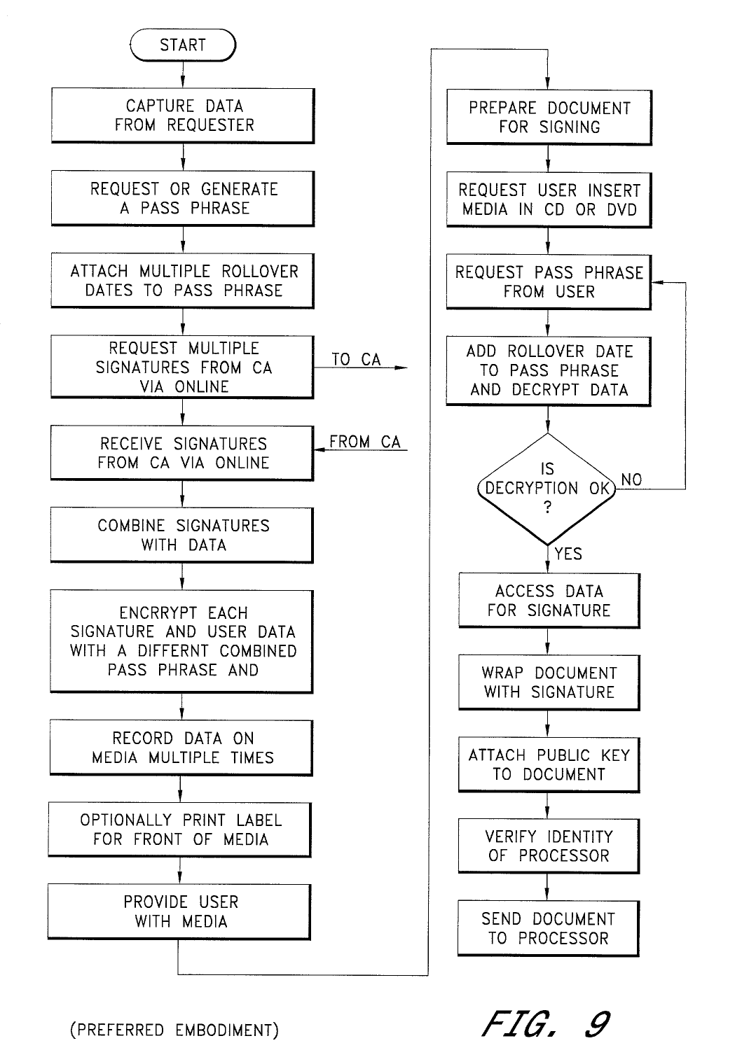

Each of the multiple signatures is combined with the data obtained from the requestor and saved with either different pass phrases or a derivative of the original pass phrase. FIG. 9 shows how using a date code can assist in aging the signature. It is a unique feature of this invention to optionally incorporate the date code as part of the password. The use of the date code need not be made public and is added automatically by software agents used to assist the requester in the signing of a document. The need for aging signatures was discussed earlier in the document. The use of a date code such as a year allows changing the actual signature used on an annual basis. In the case of date codes, the software agent that requests the pass phrase would attach the date code to the pass phrase and attempt to decrypt each digital signature until a proper decryption was encountered. The invention's intended life span is a three-year period similar to a standard credit card. In this case, four digital signatures may be encrypted on the card. One signature is used for each year and one signature is used in the event that one of the three annual signatures was compromised.

It is the preferred embodiment of this invention to record the encrypted data blocks on the media a multitude of times. This redundancy is provided in the event that the original block of data cannot be read without error. Errors will occur when the media is scratched or defects exist in the original media. In the event of an error, the software agents that access the data will scan for additional blocks containing the same data.

The Issuer records all the encrypted blocks of data on a recordable CD that can be made available to the requestor almost immediately. It is also possible to generate the invention remotely and have it mailed or delivered to requester.

The invention can optionally contain a label that makes the invention more user friendly. Possibilities exist to place the requestor's photograph and/or cursive signature on the label for possible use as a visual ID such as for a driver's license. The label is placed on the side of the media that is opposite from the recorded data.

Document signing then occurs at a later time. In prior art, the user's computer is accessed for the private key. In the preferred embodiment of this invention, a software agent is used to request the user's pass phrase, PIN or whatever form of password was used to protect the signature. If a date code is used, it is attached to the pass phrase and the software agent decrypts the data. This will prevent any other computer user from using the digital signature without also knowing the pass phrase. Should the user enter the wrong pass phrase, another attempt can be allowed immediately or there can be some form of protection added that allows only a finite number of attempts or that increases the time between attempts. This would prevent automatic cracking of the pass phrase. Thus, the invention ensures 1) the physical presence of the invention in a local drive on the computer; 2) the entry of a pass phrase usually only known by the user.

The pass phrase is then used to decrypt the proper signature from the data blocks. The photographs, signature image and fingerprint are also made available at this time.

Any courtesy images of the cursive signature are attached to the document and the document is “hashed.”

The next step can be the same or different from prior art. On prior art, the document is just prepared for delivery to the final destination. This invention has a unique feature that would attach the public key of the user to the document. In most cases, the public key of the user is published by the CA and is thus available to all requesting the key. But when aging of a key is brought into play, the key that is currently available may not have been the key used to sign the document. In the case of a thirty-year loan, it is unlikely that a CA would make the key available for twenty-nine years after the key was issued. Keys will most likely change as technology changes. Attaching a particular key to the document ensures that the key is not lost.

Prior art will then deliver the document to any entity using the software agents rules. It is a unique option of this invention to optionally verify the receiver is who they claim to be before delivering the document to the processor. This is accomplished by attaining the processor's public key and encrypting the document with that key. The key is publicly available from a CA similar in manner to a digital signature. The document is then sent to the processor who can only decrypt the document with the processor's private key. Thus, if the document is inadvertently sent to the wrong receiver, that receiver is not able to decrypt or view the document.

The invention is also intended for use as a general method of signifying that the owner is the genuine owner. This is accomplished via two methods: 1) the user must be in possession of the invention and, 2) the user must know the pass phrase to access the invention.

This makes it possible to uniquely use the invention for allowing access to a specific local computer, a remote computer, protected information, the access of financial instruments such as checks and vouchers and the use where a secure but remote form of identification is required.

What is claimed is:

1. The use of an optical disc, commonly referred to as “Compact Disc” or Digital Versatile Disc” that contains an embedded and encrypted digital signature for the use of signing legal and financial transactions over a networked environment or over the Internet.

2. The storage of a digital signature or digital certificate on a CD-ROM, CD-R, CD-RW or DVD disc for purpose of making the digital signature portable for use on several different computers without expert knowledge in the field of digital certificates.

3. The storage of a digital signature on a compact or DVD disc in encrypted form for the reasons of providing security.

4. The use of more than one digital signature on a single disc for the purpose of providing new digital signatures on a rotating or annual basis.

5. The use of more than one digital signature on a single disc for the purpose of providing immediately available additional digital signatures in the event that the current digital signature is compromised and can no longer be used in a secure manner.

6. The method of incorporating the date as part of the encryption key for protecting the digital signature. The date is added as a portion of the password or pass phrase to form a new password. The new unique password or pass phrase is then used to decrypt a new digital signature. The date can appear as either some numeric form of the date or as an obscured pass phrase or worded term.

7. The use of a software module to decrypt the digital signature contained on a compact disc or other form of media in a manner such that secure data to access the digital signature is entered and processed locally without allowing the entered password or pass phrase to leave the local computer memory.

8. The use of downloadable software components for the purpose of decrypting the digital signature. The source of the software components may be provided locally by residing on the disc containing the digital signature, as part of a third party software package or provided from a remote computer via a network environment.

9. The use of downloadable software components for the specific purpose of aging the digital signature or certificate with or without the user's knowledge. Such components would seek out the next available digital signature or certificate on an automatic basis.

10. The use of the password or pass phrase to provide the key for encrypting the digital signature thus ensuring that the actual digital signature is never entered as data to the local computer.

11. The use of multiple passwords or personal identification number values to determine which of the multiple digital signatures will be accessed.

12. The presentation of a scanned digital image of the user's signature as representation that the digital signature has been accessed properly and has been placed on the electronic document.

13. The use of providing a public key along with the document to ensure the public key is never lost and to provide easy access to the public key. The public key must be used to verify the authenticity of a document that was guarded through the use of a private key.

14. The recording of the digital signature data block a multitude of times on the storage media to provide recovery in the event that one or more images of the digital signature cannot be read from the media.

15. The use of the invention to identify to a high degree the owner of the invention for the purpose of cashing payroll or personal checks over the Internet.

16. The use of the invention for the purpose of identifying the user for certified mail concepts involving electronic mail.

17. The use of the invention to allow the printing of transferred checks that are delivered over the Internet.

18. The use of the invention as a form of identification for the purpose of conducting income tax transactions and receiving and printing refund checks or transferring the refund monies from one account to another.

19. The use of the invention as a key to access personal computers. The key is created by placing the invention into the CD or DVD drive normally found on portable computers and allowing the computer's BIOS or startup code to access the invention to ensure the proper user prior to allowing the rest of the operating system to be loaded.

20. The use of the invention as a key to access computers that are being delivered from the manufacturer to the buyer. The invention is shipped separately, such as by U.S. Mail, while the computer is sent by truck or air. Should the computer become lost or stolen, it is useless without the invention to start it up. This in turn would make the attempts to steal or hijack such shipments less desirable to thieves.
